(19) United States
(12) Patent Application Publication
(10) Pub. No.: US 2003/0160981 A1
(43) Pub. Date: Aug. 28, 2003

(54) Recognizing the content of device ready bits

(76) Inventor: Terrence M. Shannon, Kuna, ID (US)

Correspondence Address: HEWLETT-PACKARD COMPANY, Intellectual Property Administration, P.O. Box 272400, Fort Collins, CO, 80527-2400, US

(21) Appl. No.: 10/085,559

(22) Filed: Feb. 25, 2002

(51) Int. Cl. G06F 15/00; B41J 1/00

(52) U.S. Cl. 358/1.9

(57) ABSTRACT

A data recognition module recognizes the type of content (e.g. textual or photographic data) contained within a rasterized image formed of dithered device ready bits. In operation, the data recognition module associates data patterns found within the data to determine the content type of the rasterized image. Knowledge of the content type provides insight to selection of a preferred compression algorithm or other process. In one implementation, where a print driver on a workstation outputs device ready bits corresponding to a rasterized image of text, photograph or other content, the data recognition module may reside on the workstation, where it recognizes the type of content contained within the device ready bits. This information is then used to determine a preferred type of compression.

### TECHNICAL FIELD

This disclosure relates to a determination of the content of a file or a data stream. More particularly, analysis of rasterized data such as device ready bits determines if the image is text or photograph.

### BACKGROUND

A printer or other output device frequently receives a file in a PDL (page description language) such as PCL® (printer control language) or PostScript®. A PDL interpreter within the printer interprets the PDL commands, thereby creating device ready bits, which are compressed for storage, and then decompressed for transfer to a print engine. While compression relieves storage requirements and costs, a variety of difficulties are present in the compression and decompression processes.

Similarly, a printer driver on a workstation may output a rasterized image in the form of device ready bits, rather than a PDL document. In this circumstance, the device ready bits may be compressed for transmission over a network to a printer. In this application, compression of the device ready bits benefits the I/O channels in both workstation and printer, reduces network bandwidth consumption and reduces the memory requirements of the printer. However, a variety of difficulties are present in the compression and decompression processes.

Unfortunately, some inefficiency plagues the data compression and decompression process. In an effort to increase efficiency, different compression strategies have been developed, which are specialized to perform better on different types of data. For example, lossless compression strategies are preferred when used with device ready bits representing text data. However, lossy compression strategies are more efficient when used on data representing photographs. As a result, a compression and decompression strategy that combines the advantages of different compression strategies has not been previously known.

### SUMMARY

A data recognition module recognizes the type of content (e.g. textual or photographic data) contained within a data file or data stream, such as a rasterized image formed of dithered device ready bits. Recognition results from observation of data patterns found within the data, allowing determination of the content type of the rasterized image. Knowledge of the content type provides insight to selection of a preferred compression algorithm. In one implementation, where a print driver on a workstation outputs device ready bits corresponding to a rasterized image of text, photograph or other content, the data recognition module may reside on the workstation, where it recognizes the type of content contained within the device ready bits. This information is then used to determine a preferred type of compression.

### BRIEF DESCRIPTION OF THE DRAWINGS

The same numbers are used throughout the drawings to reference like features and components.

FIG. 1 is a block diagram illustrating a printer having a first implementation of an apparatus to discover the content of device ready bits.

FIG. 2 is a block diagram illustrating additional detail of a data recognition module present in the printer of FIG. 1.

FIG. 3 is a block diagram illustrating a workstation and a printer having a second implementation of an apparatus to determine the content of device ready bits.

FIG. 4 is a flow diagram that describes a method to operate a data recognition module to determine the type of content contained within data.

### DETAILED DESCRIPTION

A data recognition module recognizes the type of content (e.g. textual or photographic data) contained within a rasterized image formed of dithered device ready bits. Recognition is performed by association of data patterns found within the data to previously learned data patterns, thereby determining the content type of the rasterized image. Knowledge of the content type provides insight to selection of a preferred compression algorithm or other process. In one implementation, where a print driver on a workstation outputs device ready bits corresponding to a rasterized image of text, photograph or other content, the data recognition module may reside on the workstation. In a further implementation, where the print driver outputs a PDL (page description language) file, the PDL commands are interpreted on the printer, thereby creating device ready bits. In this case, a data recognition module may reside on the printer. In both cases, the data recognition module recognizes the type of content contained within the device ready bits. This information is then used to determine a preferred type of compression. The compressed device ready bits are then stored until needed, and decompressed prior to their ultimate use.

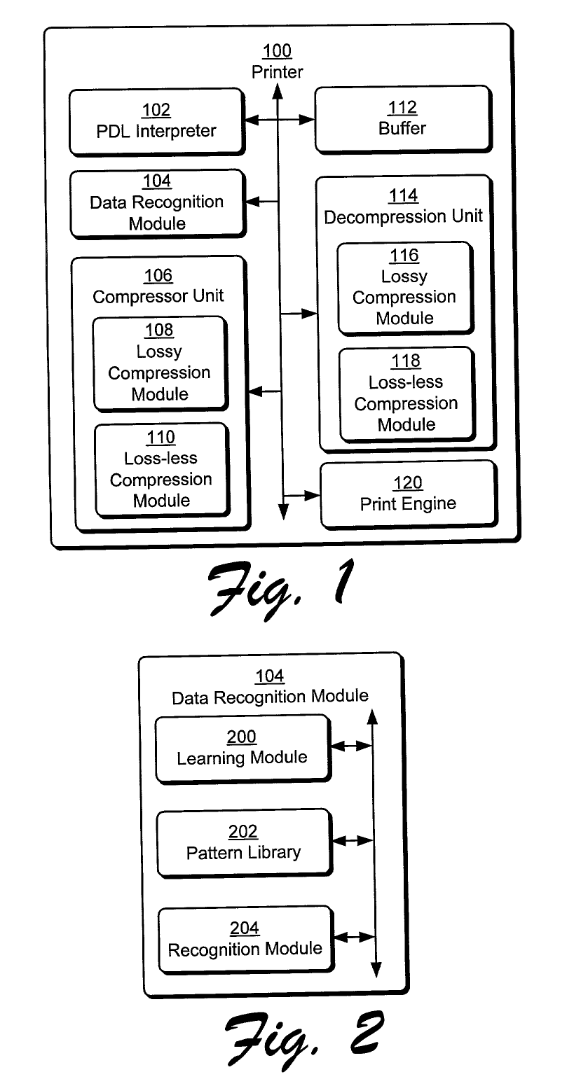

FIG. 1 shows a block diagram that illustrates various components of a first exemplary system for data content recognition, compression, and decompression. Modules seen in the figures that comprise the system are typically formed of processor-executable steps in implemented in software, but may alternatively be implemented in firmware or hardware, such as by an application specific integrated circuit. The system is particularly adapted for use where the data includes device ready bits created in a printing process to drive a print engine (e.g. the laser engine of a printer), but may alternatively be used with data of any type. A printer 100 includes a PDL interpreter 102 to interpret the commands of a PDL file sent for printing. The PDL interpreter is configured to output device ready bits, and to pass that data to a data recognition module 104.

The data recognition module 104 may be implemented in software, firmware or hardware. It is configured to view the device ready bits output from the PDL interpreter, and to determine the type of data represented by the device ready bits. The device ready bits represent “raster,” i.e. a bit-mapped picture suitable for transmission to a print engine. However, discovery of the image formed by the raster can lead to a superior choice for a method of compression of the raster data. For example, the data recognition module may recognize that the device ready bits represent either a dithered image or textual data. Accordingly, lossy or a loss-less compression may be advisable, respectively.

The compressor unit 106 includes one or more data compressor modules, or compressors, implemented in software, firmware or hardware. In the implementation of FIG. 1, a lossy compressor module 108 and a loss-less compression module 110 are illustrated. Additional compression modules could be provided, such as a plurality of lossy modules, and a plurality of loss-less modules, which are based on different compression strategies.

The compressor unit 106 is configured to invoke a particular compressor module indicated by the data recognition module. In a first example, the data recognition module may indicate that the device ready bits are associated with a photographic image. Accordingly, the data recognition module may direct the compressor unit 106 to invoke a lossy compressor module. The particular lossy compressor module selected—to which any needed parameters are passed—may be selected from among those available within the compressor unit, according to the instructions obtained from the data recognition module. In a second example, the data recognition module may indicate that the device ready bits are associated with a text-based image. Accordingly, the data recognition module may direct the compressor unit 106 to invoke a loss-less compressor module. The particular loss-less compressor module selected—to which any needed parameters are passed—may be selected from among those available within the compressor unit, according to the instructions obtained from the data recognition module.

A buffer 112 is configured to contain the output of the compressor module 106. In the implementation of FIG. 1, the buffer is configured based on a first-in/first-out configuration.

A decompressor unit 114 includes a plurality of specific decompressor modules, or decompressors, to complement the specific compressor modules found in the compressor unit 106. The decompression module may be implemented in software, firmware of hardware. In the implementation of FIG. 1, a lossy decompression module 116 and a loss-less decompression module 118 complement the corresponding lossy and loss-less compression modules found in the compression unit 106. Thus, the decompressor unit provides decompression modules which decompress data according to the compression previously applied to the data.

The decompression unit is configured to select the appropriate decompression module according to the compression used. The selected decompression module is configured to decompress data from the buffer 112, and to pass the decompressed data to the print engine 120 for output. The print engine may be based on the technology seen in laser engines, or any desired alternative.

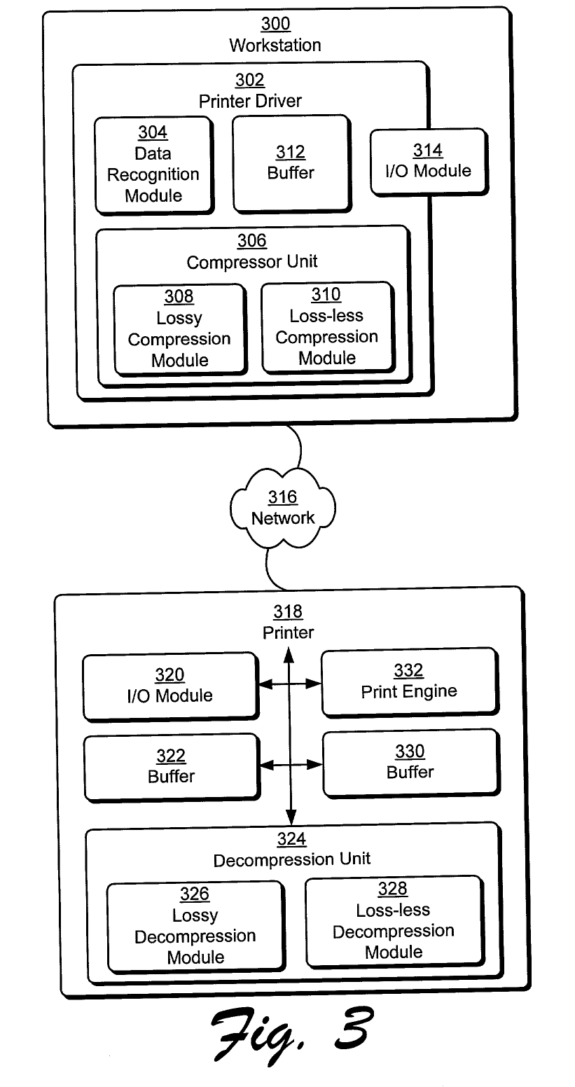

FIG. 2 shows a detailed view of the data recognition module 104. A learning module 200 is configured to associate data patterns found in device ready bits with the file type from which the device ready bits are derived. To make such an association, the learning module monitors and counts the instances of patterns found frequently in the device ready bits, or raster data, in a particular type of document. In particular, the learning module determines those patterns that are heavily prevalent in the device ready bit or raster data associated with a first type of image (e.g. an image of text) but which are found only rarely in the device ready bits associated with other file types (e.g. photographic images). Therefore, the learning module determines those patterns that are found with very high frequency in the device ready bits of files of certain content types (e.g. text), but which are found only rarely in the device ready bits associated with files of other content type (e.g. photographs). Accordingly, this information can be used to determine the file type (e.g. text or photo) by looking at the device ready bits derived from a file or data stream.

The patterns for which the learning module looks may be particular values for bytes (i.e. 8 bits) or nibbles (i.e. 4 bits) of data. For example, where the learning module is advised by keyboard command or other means that the device ready bits received are a result of a photographic image, the learning module will associate the frequency of certain patterns with photographic images. Similarly, where the learning module is advised that the device ready bits received are a result of a textual image (raster data that will result in the output of printed text), the learning module will associate the frequency of certain patterns with text images.

A pattern library 202 is configured to store the associations, between patterns (e.g. 4-bit nibbles of data) within the device ready bits and types of documents from which the device ready bits were derived. For example, the learning module 200 may discover the information seen in Table 1, which is recorded in the pattern library 202.

| | Occurrences in page of raster | Occurrences in page of |
|---|---|---|
| Pattern | data from photographic image | raster data from text image |
| 0x03 | 0 | 95,181 |
| 0x04 | 81,071 | 1,578 |
| 0x06 | 637,913 | 5,823 |
| 0x07 | 1,221 | 94,758 |
| 0x08 | 1,243 | 98,046 |
| 0x09 | 266,223 | 1,146 |
| 0x0C | 3 | 97,459 |

Table 1 illustrates exemplary data obtained using a monochrome dither matrix that is typically used in Hewlett-Packard® monochrome LaserJet® printers. If other dither matrices were used, or if color dither matrices were used, the patterns (e.g. hex values) and their rate of occurrence may change. However, Table 1 illustrates that, given a particular set of dither matrixes data patterns exist that are found at vastly different rates in photographic and textual content data types. Table 1 is representative only, in that additional columns of data could be added, as desired, to represent types of content in addition to photographs and text.

Column 1 of Table 1 illustrates a plurality of data patterns, represented by nibbles of data corresponding to seven different hex values between three (0×03) and twelve (0×0C). Columns 2 and 3 record the number of times each pattern is found in the raster image or device ready bits of one page of data. In particular, it can be seen that the data patterns 0×03, 0×07, 0×08 and 0×0C are very highly associated with the device ready bits used to output text, and very weakly associated with the device ready bits used to output photographs. Similarly, the data patterns 0×04, 0×06, and 0×09 are very highly associated with the device ready bits used in association with photographic images, and very weakly associated with the device ready bits used to output text.

A recognition module 204 is configured to associate data patterns and content types, thereby recognizing content types from the raster data. The recognition module uses data similar to that seen in Table 1, stored in the pattern library 202, to determine the content type of the image (text, photo, etc.) which is represented by a data stream or data file of device ready bits. The raster data is examined briefly, until pattern recognition indicates that the likelihood of correct content type is sufficiently certain. At this time, the data recognition module 104 can indicate to the compressor 106 the nature of the content of the image contained in the device ready bits, allowing the compressor to select the correct compression module.

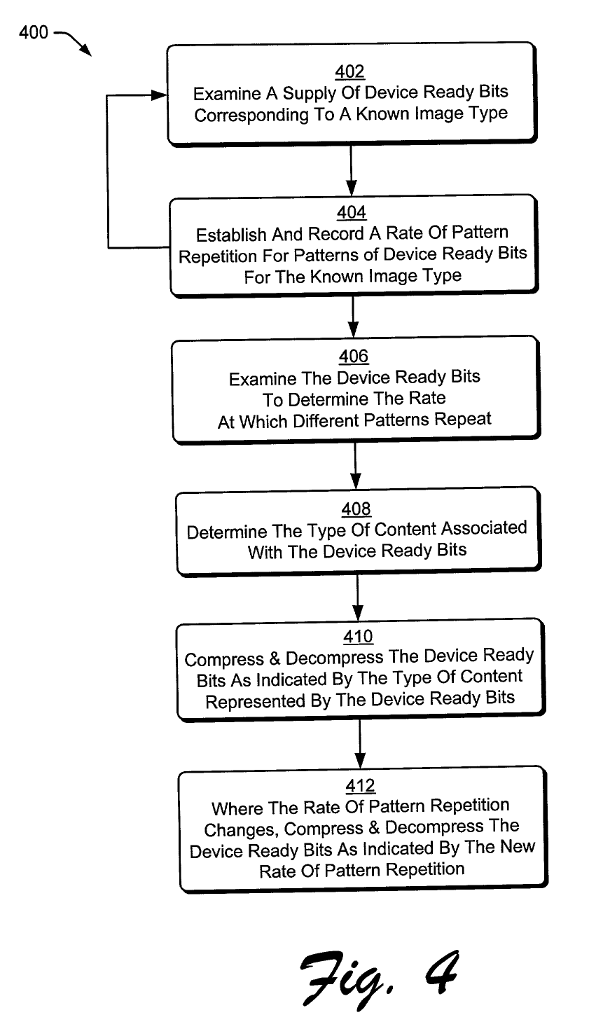

FIG. 3 shows a block diagram that illustrates various components of a second exemplary system for data content recognition, compression, and decompression. Modules seen in the figures that comprise the system are typically formed of processor-executable steps in implemented in software, but may alternatively be implemented in firmware or hardware, such as by an application specific integrated circuit. The system is particularly adapted for use where the data includes device ready bits created in a printing process to drive a print engine, but may alternatively be used with data of any type. In a manner similar to the implementation of FIG. 1, the content of device ready bits is recognized to allow implementation of an effective compression strategy. In this implementation, the device ready bits are compressed by the print driver resident on the workstation, and then decompressed within the printer prior to the actual image print time.

A workstation 300 includes a print driver 302, which produces a raster image comprising device ready bits in response to a print command given to an application. The device ready bits pass from the print driver into a workstation-based data recognition module 304, which is configured in a manner similar to the printer based data recognition module 104. Accordingly, the data recognition module examines the device ready bits that comprise the raster image output from the print driver, and determines the image's content type, i.e. if the image is one of text, a photograph, line art, etc.

The compressor unit 306 receives an indication of the content type of the image from the data recognition module. In response, the compressor unit selects the proper compression strategy from among those available. For example, where the content type is photographic in nature, the compressor module selects a lossy compression module 308. Similarly, where the content type is text-based, the compressor module selects a loss-less compression module 310. Using the appropriate compression module, the compressor compresses the device ready bits generated by the print driver.

The compressed device ready bits may be stored briefly in a buffer 312 before passing from an I/O module 314, over the network 316 and into the printer 318.

The printer 318 includes an I/O module 320 that receives data to be printed, which can be in the form of compressed device ready bits which comprise the raster data of the image to be printed. This data may be stored in a buffer 322 until it must be decompressed. A decompression unit 324 selects an appropriate decompression module, such as a lossy decompression module 326 or a loss-less decompression module 328 to decompress the compressed device ready bits generated by the print driver. The decompressed device ready bits may be stored temporarily in a buffer 330 before transfer to the print engine 332.

FIG. 4 shows a method 400 to recognize the type of content (e.g. text or photographic) of any type of data, such as device ready bits (e.g. raster image data derived from interpretation of PDL commands or derived from a print driver and used to drive the print engine of a printer). Having recognized the content type, the method intelligently directs the nature and type of the compression and decompression used to manage the data. The method recognizes and uses the content type by: learning and recording data patterns found in the device ready bits which are particularly associated with different types of known images; examining device ready bits representing raster images of unknown content type and finding the learned and recorded data patterns, thereby discovering the type of content with which the device ready bits are associated; and, advising a compressor module to employ a compression module appropriate to the discovered content type.

At block 402, a supply of device ready bits corresponding to an image of known content type are examined. The device ready bits may be received from a print driver or by interpretation of commands within a PDL file. For example, a PDL file of an image of known content type (e.g. text or photograph) may be sent to a PDL interpreter. The PDL used can be PLC® (Printer Control Language), PostScript® or other page description language. As the commands of the PDL file are interpreted, device ready bits are produced. Alternatively, the device ready bits may be produced directly from a print driver.

At block 404, rates of repetition of patterns of device ready bits associated with raster images of known content type are established and recorded. The device ready bits are examined by a learning module or similar module or structure. The patterns can be data segments of any length, such as the 4-bit segments seen in the first column of Table 1. The raster images of known content type may be raster images of text, of photographs, or line art or of other media. By establishing a rate at which different patterns are repeated, data such as that seen in columns 2 and 3 of Table 1 is generated.

Blocks 402 and 404 can be repeated for device ready bits comprising different content types, such as photographs, text, line art, etc. Accordingly, a table similar to Table 1 may be produced and stored, thereby building a pattern library. The table produced may have a number of columns, each corresponding to device ready bits associated with raster images having different content types.

At block 406, the device ready bits are examined to determine the rate at which different patterns repeat. The device ready bits may be created by interpretation of a PDL file sent to a printer, or they may be created directly by a print driver. In one implementation, the device ready bits are received by a recognition module or similar module. The device bits are examined for the occurrence of different patterns, and the rate of repetition for the different patterns is calculated. The quantity of device ready bits examined before the rate is calculated should be selected to be sufficient to determine the content type to a high degree of confidence, yet not so large as to require that an excessive quantity of device ready bits be buffered.

At block 408, the rate of pattern repetition is compared to the table of pattern repetition stored in the pattern library. The type of content associated with the device ready bits is then determined. A key factor is that certain data patterns are overwhelmingly associated with raster images having certain types of content (e.g. text, photo, etc.). According in to this factor, the occurrence or nonoccurrence of these data patterns in the device ready bits is a very strong indication of the content associated with the raster image formed by the device ready bits. Accordingly, the type of content associated with the device ready bits is determined.

At block 410, the device ready bits are compressed and decompressed in a manner indicated by the content type of the raster image formed by the device ready bits. The data recognition module—or similar module examining the device ready bits to determine the type of content that the device ready bits represent—indicates to the compressor module the nature of the content. The compressor unit then selects an appropriate compression module, based on the content type. For example, where the content is textual, a loss-less compression algorithm will prevent the formation of artifacts when the device ready bits are uncompressed and sent to the print engine. Alternatively, where the content is a photographic image, a lossy compression algorithm is typically more efficient.

At block 412, a change in the rate of the repetition of one or more patterns may indicate that the content type has changed. For example, where a page of content includes both photographic and text-based content, the raster image formed by the device ready bits may shift from a first type of content to a second type of content. As a result, the rate of pattern repetition within the device ready bits may also change, indicating the shift. Accordingly, after a change in the rate of pattern repetition, the method of compression may be changed at the point indicated by the shift in pattern repetition rates. Thus, if desired, the photographic and text-based content on a single page of print output may be compressed using different means.

In conclusion, a method and apparatus determines the type of data compression to be used to compress device ready bits. A print driver on a workstation may output device ready bits. Alternatively, a PDL interpreter on a printer may output device ready bits as a PDL document sent from a workstation is interpreted. A data recognition module examines data patterns within the device ready bits, and thereby recognizes the type of content contained within the raster image which will result from the output of the device ready bits. This information is then used to determine the type of compression to be used. The compressed device ready bits are then stored until needed, and decompressed by an appropriate module prior to their transmission to the print engine.

Although the disclosure has been described in language specific to structural features and/or methodological steps, it is to be understood that the appended claims are not limited to the specific features or steps described. Rather, the specific features and steps are exemplary forms of implementing this disclosure. For example, while exemplary data patterns have been disclosed, the data patterns are dependent upon many factors, such as the nature of the print driver and PDL interpreter used. Accordingly, data patterns and their frequency of occurrence may vary for any particular application.

Additionally, while one or more implementations and methods have been disclosed by means of flow charts and text associated with the blocks, it is to be understood that the blocks do not necessarily have to be performed in the order in which they were presented, and that an alternative order may result in similar advantages.

1. A processor-readable medium comprising processor-executable instructions for:
comparing a rate of pattern repetition in data to recorded rates of pattern repetition;
determining a content type using the rate of pattern repetition and the recorded rates of pattern repetition; and
compressing and decompressing data in a manner appropriate to the content type.

2. A processor-readable medium as recited in claim 1, additionally comprising instructions for:
determining data patterns that are frequently found in a first content type and which are infrequently found in a second content type.

3. A processor-readable medium as recited in claim 1, additionally comprising instructions for:
examining data of a known content type;
recording rates of pattern repetition found in the data of the known content type.

4. A processor-readable medium as recited in claim 1, additionally comprising instructions for:
after the rate of pattern repetition changes, compressing and decompressing data according to a new content type.

5. A processor-readable medium as recited in claim 1, additionally comprising instructions for:
building a pattern library by recording rates of pattern repetition from data of a known content type.

6. A system for data content recognition, compression, and decompression, comprising:
a data recognition module to recognize a content type of data;
a compressor to compress the data according to the content type; and
a decompressor to decompress the data according to the content type.

7. The system of claim 6, wherein the data comprises device ready bits appropriate to drive a print engine.

8. The system of claim 7, additionally comprising:
a buffer, within which the device ready bits reside after compression and before decompression.

9. The system of claim 6, wherein the compressor is on a workstation and the decompressor is on a printer.

10. The system of claim 6, wherein the compressor and the decompressor are on a printer.

11. The system of claim 6, additionally comprising:
a PDL interpreter to supply the data to the data recognition module.

12. The system of claim 6, additionally comprising:
a print engine to receive the data after decompression.

13. The system of claim 6, additionally comprising:
a learning module, in communication with the data recognition module, to learn relationships between a plurality of data patterns associated with a plurality of content types.

14. The system of claim 6, additionally comprising:
a pattern library, in communication with the data recognition module, to store information on relationships between data patterns and content types.

15. The system of claim 6, additionally comprising:
a recognition module, in communication with the data recognition module, to associate data patterns and content types.

16. A printer, comprising:
a data recognition module to recognize a content type of device ready bits;
a compressor to compress the device ready bits according to the content type of the device ready bits;
a buffer to store the device ready bits after compression and before decompression;
a decompressor to decompress the device ready bits according to compression of the device ready bits; and
a print engine to receive the device ready bits after decompression.

17. The printer of claim 16, additionally comprising:
a PDL interpreter to interpret a PDL print job and to supply the device ready bits.

18. The printer of claim 16, wherein the data recognition module additionally comprises:
a learning module to learn relationships between a plurality of data patterns and a plurality of content types.

19. The printer of claim 18, wherein the data recognition module additionally comprises:
a pattern library to store information on the relationships.

20. The printer of claim 16, wherein the data recognition module additionally comprises:
a recognition module to associate data patterns and content types.

21. A method for data content recognition, compression, and decompression, comprising:
examining data for pattern repetition;
comparing a rate of pattern repetition to recorded rates of pattern repetition;
determining a content type of the data; and
compressing the data in a manner appropriate to the content type of the data.

22. The method of claim 21, additionally comprising:
decompressing the data in a manner appropriate to the content type of the data.

23. The method of claim 21, wherein the data comprises device ready bits.

24. The method of claim 21, additionally comprising:
examining data of known content type; and recording rates of data pattern repetition.

25. The method of claim 21, additionally comprising:
building a pattern library by recording rates of pattern repetition from device ready bits from data of known content type.

26. The method of claim 21, additionally comprising:
after the rate of pattern repetition changes, compressing and decompressing device ready bits according to a new content type.

27. A processor-readable medium comprising processor-executable instructions for:
examining data for pattern repetition;
comparing a rate of pattern repetition to recorded rates of pattern repetition;
determining a content type of the data; and
compressing the data in a manner appropriate to the content type of the data.

28. A processor-readable medium as recited in claim 27, additionally comprising instructions for:
decompressing the data in a manner appropriate to the content type of the data.

29. The processor-readable medium of claim 27, wherein the data comprises device ready bits.

30. A processor-readable medium as recited in claim 27, additionally comprising instructions for:
examining data of known content type; and
recording rates of data pattern repetition.

31. A processor-readable medium as recited in claim 27, additionally comprising instructions for:
building a pattern library by recording rates of pattern repetition from device ready bits from data of known content type.

32. A processor-readable medium as recited in claim 27, additionally comprising instructions for:
after the rate of pattern repetition changes, compressing and decompressing device ready bits according to a new content type.
